(19) United States
(12) Patent Application Publication
(10) Pub. No.: US 2013/0163106 A1
(43) Pub. Date: Jun. 27, 2013

(54) AUTO-FOCUSING LENS MODULE

(71) Applicant: JEN-TSORNG CHANG, Tu-Cheng (TW)

(72) Inventor: JEN-TSORNG CHANG, Tu-Cheng (TW)

(73) Assignee: HON HAI PRECISION INDUSTRY CO., LTD., Tu-Cheng (TW)

(21) Appl. No.: 13/596,062

(22) Filed: Aug. 28, 2012

(30) Foreign Application Priority Data
Dec. 27, 2011 (TW) 100149024

(51) Int. Cl. G02B 7/09

(52) U.S. Cl. 359/824; 359/823

(57) ABSTRACT

An auto-focusing lens module includes a substrate, guiding members positioned on the substrate, an actuator unit, a driving plate, and a lens holder holding a lens therein. The driving plate includes an upper surface and first protrusions on the upper surface in a first circle. A height of each first protrusion gradually decreases along a circumferential direction. The lens holder includes a bottom surface and second protrusions on the bottom surface in a second circle. A height of each second protrusion gradually increases along the circumferential direction. Each second protrusion rests on a respective first protrusion. The guiding members guide the lens holder to move along an optical axis of the lens module. The actuator unit drives the driving plate to rotate, such that the driving plate drives the lens holder to move long the optical axis by the engagement of each second protrusion with the respective first protrusion.

### BACKGROUND

1. Technical Field

The present disclosure relates to lens modules, and particularly to an auto-focusing lens module.

2. Description of Related Art

Current focusing mechanisms typically employ cam structures for guiding lenses to move to find a focus position, which is complicated and costly.

What is needed therefore is an auto-focusing lens module addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an exploded view of an auto-focusing lens module, according to an exemplary embodiment of the present disclosure.

FIG. 2 is an assembled view of the auto-focusing lens module of FIG. 1.

FIG. 3 is a cross sectional view of the auto-focusing lens module of FIG. 2, taken along line III-III.

### DETAILED DESCRIPTION

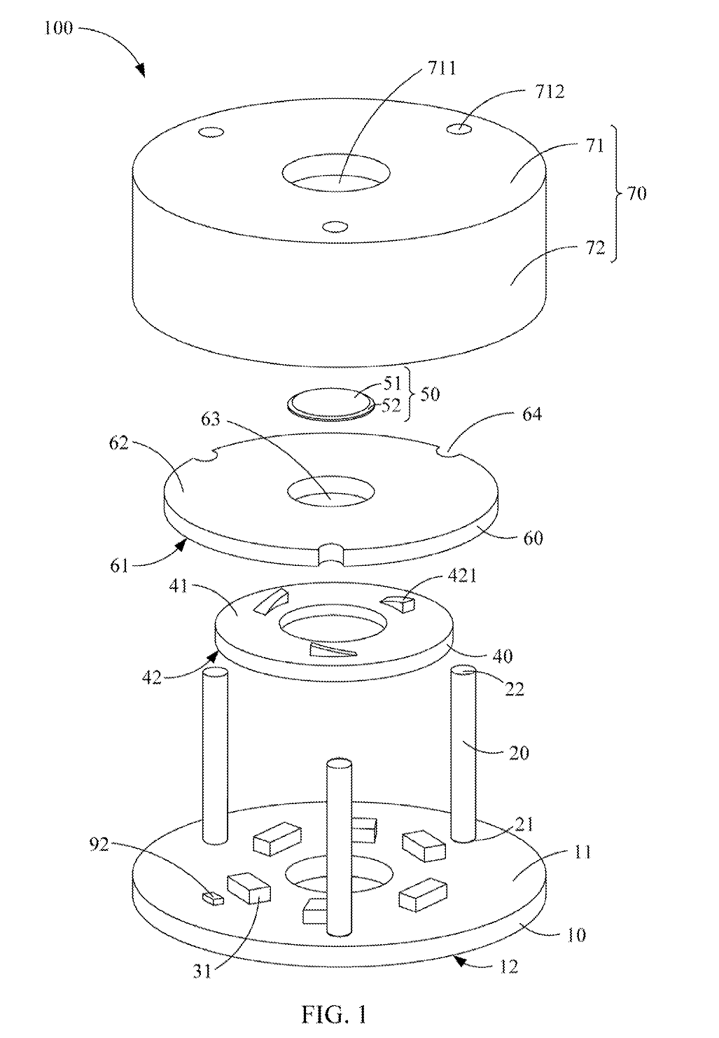

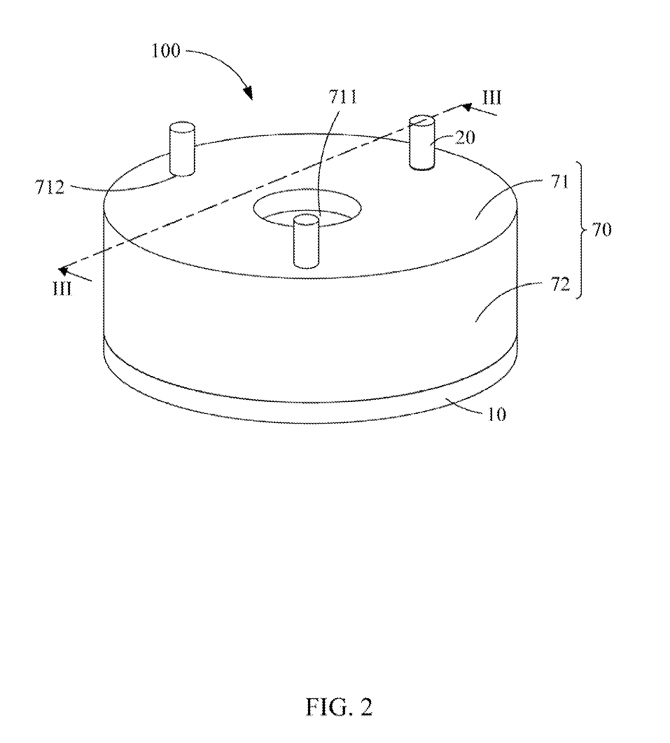

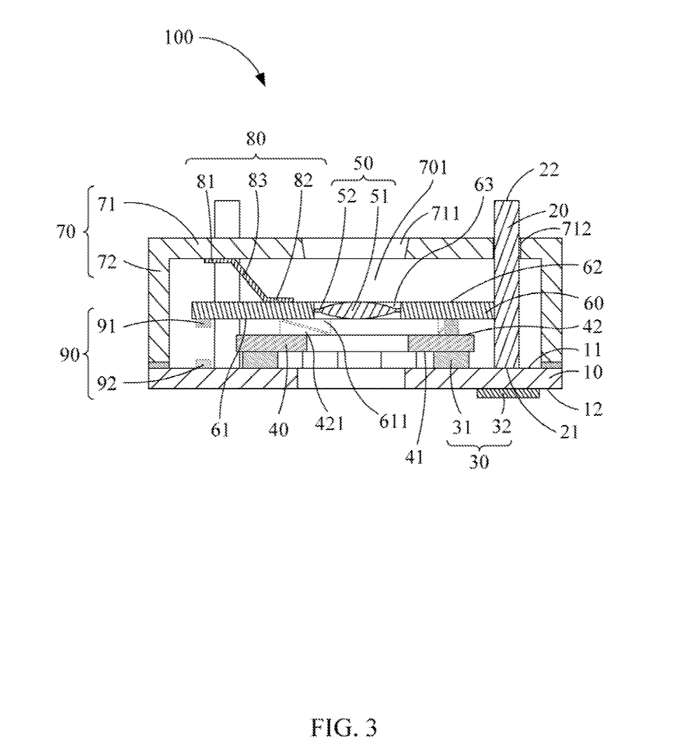

Referring to FIGS. 1-3, an auto-focusing lens module 100, according to an exemplary embodiment, is shown. The auto-focusing lens module 100 includes a substrate 10, a number of guiding members 20, an actuator unit 30, a driving plate 40, a lens 50, a lens holder 60, and a cover 70.

The substrate 10 is substantially ring-shaped. The substrate 10 includes a first surface 11 and an opposite second surface 12. The substrate 10 is made from a rigid material, such as ceramic or resin.

Each of the guiding members 20 is substantially column-shaped and includes a first end 21 and an opposite second end 22. The first end 21 is fixedly connected to the first surface 11 of the substrate 10. The guiding members 20 are equidistantly arranged along a circle concentric with the substrate 10. In the embodiment, the number of the guiding members 11 is three.

The actuator unit 30 includes a number of piezoelectric actuators 31 and a driving chip 32 electrically connected to the piezoelectric 31. The piezoelectric actuators 31 are fixed on the first surface 11 of the substrate 10. In the embodiment, the piezoelectric actuators 31 are adhered on the first surface 11 using glue. The piezoelectric actuators 31 are arranged along a circle around the center of the substrate 10. In the embodiment, the driving chip 32 is fixed on the second surface 12. Alternatively, the driving chip 32 can be formed on the first surface 11.

The driving plate 40 is substantially ring-shaped. The driving plate 40 includes an upper surface 41, a lower surface 42 opposite to the upper surface 41, and a number of first protrusions 421 formed on the upper surface 41. The first protrusions 421 are arranged along a circle concentric with the driving plate 40. Each first protrusion 421 is arc-shape and extends along the circle. A height of each first protrusion 421 gradually decreases along a circumferential direction of the circle. In this embodiment, the number of the first protrusions 421 is three, and the height of each protrusion 421 gradually decreases along a counterclockwise circumferential direction of the circle, viewed from a direction from the upper surface 41 to the lower surface 42.

The driving plate 40 is positioned on the substrate 10 within the circle defined by the guiding members 20, with each of the guiding members 20 touching the driving plate 40. The lower surface 42 is attached on the piezoelectric actuators 31.

The lens 50 includes an optical portion 51 and a fixing portion 52 surrounding the optical portion 51. In the embodiment, the optical portion 51 and the fixing portion 52 are wholly formed with each other.

The lens holder 60 is substantially ring-shaped for holding the lens 50. The lens holder 60 includes a bottom surface 61 and an opposite top surface 62. The holder 60 includes a number of second protrusions 611 formed on the bottom surface 61 spatially corresponding to the first protrusions 421. The second protrusions 611 are arranged along a circle concentric with the lens holder 60. Each second protrusion 611 is arc-shaped. A height of each second protrusion 611 gradually changes along the circle. In this embodiment, the height of each second protrusion 611 gradually increases along a counterclockwise circumferential direction of the circle, viewed from the top surface 62 to the bottom surface 61. The lens holder 60 defines a central fixing hole 63 passing through the bottom surface 61 and the top surface 62 and a number of peripheral guiding grooves 64 in a peripheral surface of the lens holder 60. The fixing hole 60 receives the lens 50. The fixing portion 52 is fixed to an inner surface of the fixing hole 63. The grooves 64 spatially correspond to the guiding members 20. In the embodiment, each groove 64 is substantially a semi-cylindrical cutout and spatially corresponds to a respective one of the guiding members 20.

The lens holder 60 is positioned on the driving plate 40. Each guiding member 20 is slidably engaged into a corresponding groove 64. Each second protrusion 611 slides on a corresponding first protrusion 421 to lift or lower the lens holder 60. In detail, a higher end of each second protrusion 611 is positioned on a lower end of a corresponding first protrusion 421 along a direction parallel to the optical axis of the lens 50, and a lower end of each second protrusion 611 is positioned on a higher end of a corresponding first protrusion 421 along a direction parallel to the optical axis of the lens 50.

The cover 70 includes a top plate 71 and a sidewall 72 connected to the top plate 71. The top plate 71 defines a central through hole 711 and a number of peripheral through holes 712 around the central through hole 711. The peripheral through holes 712 spatially correspond to the guiding members 20. The central through hole 711 allows light to pass therethrough. The sidewall 72 is substantial a hollow cylinder. The sidewall 72 and the top plate 71 cooperatively define a receiving space 701.

A bottom end of the sidewall 72 is connected to the substrate 10 to receive the piezoelectric actuators 31, the driving plate 40, the lens 50 and the lens holder 60 into the receiving space 701. The second end 22 of each guiding member 20 passes through a corresponding peripheral through hole 712.

The auto-focusing lens module 100 further includes an elastic member 80 compressed between the top surface 62 and the top plate 71 of the cover 70. The elastic member 80 provides a preload pressure on the lens holder 60. Under the preload pressure, the lens holder 60 is tightly pressed on the driving plate 40, and the driving plate 40 is tightly pressed on the piezoelectric actuators 31. The elastic member 80 includes a first supporting foot 81, a second supporting foot 82 and a connecting portion 83 connected between the first supporting foot 81 and the second supporting foot 82. The first supporting foot 81 and the second supporting foot 82 are substantially parallel to each other. The first supporting foot 81 is fixed on an inner surface of the top plate 71, and the second supporting foot 82 contacts on the top surface 62 of the lens holder 60.

The auto-focusing lens module 100 further includes a position detector 90 for detecting a position of the lens 50 and transmitting the detecting result to the driving chip 32. The position detector 90 includes a magnet 91 and a Hall member 92. The magnet 91 is fixed on the bottom surface 61 of the lens holder 60, and the Hall member 92 is fixed on the first surface 11 of the substrate 10. The magnet 91 and the Hall member 92 are aligned with each other along a direction parallel to the optical axis of the lens 50. In other embodiments, the magnet 91 can be fixed on the first surface 11 of the substrate 10, and the Hall member 92 can be fixed on the bottom surface 61 of the lens holder 60. The magnet 91 and the Hall member 92 are aligned with each other along a direction parallel to the optical axis of the lens 50.

In operation, the driving chip 32 controls an input electric current to the piezoelectric actuators 31. The piezoelectric actuators 31 are deformed under the electric current to drive the driving plate 40 to rotate along a counterclockwise direction, viewed from the direction from the upper surface 41 to the lower surface 42. The first protrusions 421 press the second protrusions 421 during the rotation of the driving plate 40. Thus, the lens holder 60 is driven to move away from the substrate 10 along the guiding members 20. The position of the lens 50 is changed under the carrying of the lens holder 60. During the movement of the lens holder 60, the elastic member 80 is further compressed between the lens holder 60 and the top plate 71 of the cover 70. In addition, the magnet 91 forms a magnetic field surrounding the Hall member 92. If the lens holder 60 is moved along the guiding members 20, an intensity of the magnetic field at the location of the Hall member 92 is accordingly changed. The Hall member 92 detects a position of the lens 50 according to the change of intensity of the magnetic field surrounding itself. The detecting result of the Hall member 92 is transmitted to the driving chip 32. The driving chip 32 controls the input electric current according to the detecting result of the Hall member 92, thus the lens 50 can be moved to a proper focusing position.

The driving chip 32 stops to provide electric current when there is no need to focus. The shapes of the piezoelectric actuators 31 are restored to drive the driving plate to rotate along a clockwise direction, viewed from the direction from the upper surface 41 to the lower surface 42. The elastic member 80 presses the lens holder 60 to move toward the substrate 10.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An auto-focusing lens module, comprising:
a substrate comprising a first surface and a second surface opposite to the first surface;
a plurality of guiding members positioned on the first surface and extending in a direction parallel to an optical axis of the lens module;
an actuator unit;
a driving plate engaging with the actuator unit and comprising an upper surface, a lower surface, and a plurality of first protrusions on the upper surface, the first protrusions arranged in a first circle, a height of each first protrusion gradually decreasing along a circumferential direction; and
a lens holder holding a lens therein, the lens holder comprising a top surface, a bottom surface, and a plurality of second protrusions on the bottom surface, the second protrusions arranged in a second circle, a height of each second protrusion gradually increasing along the circumferential direction, each second protrusion spatially corresponding a respective one of the first protrusions and resting on the respective first protrusion;
wherein the guiding members engage with the lens holder and are configured for guiding the lens holder to move along the optical axis of the lens module, and the actuator unit is configured for driving the driving plate to rotate around the optical axis of the lens module, such that the driving plate drives the lens holder to move long the optical axis of the lens module by the engagement of each second protrusion with the respective first protrusion.

2. The auto-focusing lens module of claim 1, further comprising a cover connected to the substrate, all of the actuator unit, the driving plate, the lens holder and the lens being received in the cover.

3. The auto-focusing lens module of claim 2, wherein the cover comprises a top plate and a sidewall connected to the top plate, the sidewall is connected to the substrate.

4. The auto-focusing lens module of claim 3, wherein the top plate defines a central through hole and a plurality of peripheral through holes around the central through hole, the central through hole allows light to pass therethrough, a distal end of each guiding member passes through a corresponding one of the peripheral through holes.

5. The auto-focusing lens module of claim 3, further comprising an elastic member compressed between the lens holder and the top plate of the cover, the elastic member configured for providing a preload pressure between the lens holder and the top plate of the cover.

6. The auto-focusing lens module of claim 5, wherein the elastic member comprises a first supporting foot, a second supporting foot and a connecting portion connected between the first supporting foot and the second supporting foot, the first supporting foot is fixed on the top plate, and the second supporting foot touches the top surface of the lens holder.

7. The auto-focusing lens module of claim 6, wherein the first supporting foot and the second supporting foot are substantially parallel to each other.

8. The auto-focusing lens module of claim 1, wherein the guiding members are uniformly arranged in a third circle concentric with the substrate.

9. The auto-focusing lens module of claim 8, wherein each of the guiding members is substantially column-shaped.

10. The auto-focusing lens module of claim 1, wherein the actuator unit comprises a plurality of piezoelectric actuators and a driving chip electrically connected to the piezoelectric actuators, the piezoelectric actuators are positioned on the first surface and support the lower surface of the driving plate, the driving chip is configured for controlling the piezoelectric actuators to rotate the driving plate.

11. The auto-focusing lens module of claim 10, wherein the piezoelectric actuators are arranged in a fourth circle concentric with the substrate.

12. The auto-focusing lens module of claim 1, wherein each first protrusion is arc-shaped.

13. The auto-focusing lens module of claim 1, wherein the lens holder defines a plurality of peripheral guiding grooves in its peripheral surface, each guiding member is slidably engaged into a corresponding one of the peripheral guiding grooves.

14. The auto-focusing lens module of claim 13, wherein each peripheral guiding groove is substantially a semi-cylindrical cutout.

15. The auto-focusing lens module of claim 1, further comprising a position detector for detecting a position of the lens and transmitting the detecting result to the actuator unit.

16. The auto-focusing lens module of claim 15, wherein the position detector comprises a magnet and a Hall member, one of the magnet and the Hall member is fixed on the bottom surface of the lens holder, and the other one of the magnet and the Hall member is fixed on the first surface of the substrate.

17. The auto-focusing lens module of claim 16, wherein the magnet and the Hall member are aligned with each other along a direction parallel to the optical axis of the lens module.

18. The auto-focusing lens module of claim 1, wherein a higher end of each second protrusion rests on a lower end of the respective first protrusion along a direction parallel to the optical axis of the lens module, a lower end of each second protrusion rests on a higher end of the respective first protrusion along the direction parallel to the optical axis of the lens module.
